(19) United States
(12) Patent Application Publication
(10) Pub. No.: US 2019/0043041 A1
(43) Pub. Date: Feb. 7, 2019

(54) METHOD FOR MANAGING AN ELECTRONIC CARD AND ELECTRONIC DEVICE THEREOF

(71) Applicant: SAMSUNG ELECTRONICS CO., LTD., Suwon-si (KR)

(72) Inventors: Jun Kyoung SHIN, Gumi-si (KR); Yi YANG, Suwon-si (KR); Ingwon HONG, Suwon-si (KR); Sung-Jun KIM, Daegu (KR)

(21) Appl. No.: 16/052,882

(22) Filed: Aug. 2, 2018

(30) Foreign Application Priority Data
Aug. 2, 2017 (KR) 10-2017-0098041

(51) Int. Cl. G06Q 20/36; G06Q 20/40

(52) U.S. Cl. CPC G06Q 20/367; G06Q 20/401

(57) ABSTRACT

Various embodiments of the present disclosure relate to a method of managing an electronic device stored in a security element, and the electronic device thereof. The electronic device may include a housing, a display exposed through a part of the housing, a security element comprising a secure storage area disposed inside the housing and configured to store payment-related information, a processor disposed inside the housing and operatively coupled with the security element, and a memory disposed inside the housing and operatively coupled with the processor. The memory may store an application program which is configured to manage and/or use the payment-related information. The memory may store instructions, which when executed by the processor, cause the electronic device to receive an input for selecting the application program, delete the application program in response to the received input, identify at least one item from the payment-related information stored in the security element upon deleting of the application program, and deactivate the identified at least one item.

### CROSS REFERENCE TO RELATED APPLICATION

This application is based on and claims priority under 35 U.S.C. § 119 to Korean Patent Application No. 10-2017-0098041, filed on Aug. 2, 2017, in the Korean Intellectual Property Office, the disclosure of which is incorporated by reference herein in its entirety.

### BACKGROUND

### Field

The present disclosure relates to a method of managing an electronic card stored in a security element, and an electronic device thereof.

### Description of Related Art

With the advance of information communication techniques and semiconductor techniques, an electronic device can provide various services such as a broadcasting service, a wireless Internet service, a camera service, a user authentication service, and an electronic payment service. The electronic device may use an electronic card registered in the electronic device via various services to pay for a product or to authenticate a user. Since the electronic device requires security for the electronic card, the electronic card may be stored in a separate security element (e.g., an embedded Security Element (eSE)).

The electronic device may store the electronic card in the security element in a form of a card applet via an application program for managing the electronic card. The electronic device may access and manage the electronic card stored in the security element via the application program for managing the electronic card.

When the application program for managing the electronic card is deleted or the electronic device is reset (e.g., a factory reset), a pre-stored electronic card may still remain in the security element. Therefore, the presence of the electronic card in the security element may result in payment or the like which is not intended by a user.

### SUMMARY

Accordingly, various embodiments of the present disclosure provide an apparatus and method for managing an electronic card.

Advantageous effects of the present disclosure are not limited to the aforementioned advantageous effects, and other unmentioned advantageous effects can be clearly understood by those skilled in the art from descriptions below.

According to various embodiments of the present disclosure, an electronic device may include a housing, a display exposed through a part of the housing, a security element comprising a secure storage disposed inside the housing and configured to store payment-related information, a processor disposed inside the housing and operatively coupled with the security element, and a memory disposed inside the housing and operatively coupled with the processor. The memory may store an application program configured to manage and/or use the payment-related information. The memory may store instructions which, when executed by the processor, cause the electronic device to: receive an input for selecting the application program, delete the application program in response to the received input, identify at least one item from the payment-related information stored in the security element upon deleting of the application program, and deactivate the identified at least one item.

According to various embodiments of the present disclosure, an electronic device may include a housing, a display exposed through a part of the housing, a security element comprising a secure storage disposed inside the housing and configured to store payment-related information, a processor disposed inside the housing and operatively coupled with the security element, and a memory disposed inside the housing and operatively coupled with the processor. The memory may store an application program configured to manage and/or use the payment-related information. The memory may store instructions which, when executed by the processor, cause the electronic device to: receive an input for for resetting the electronic device to an initial setup, reset the electronic device to the initial setup, and deactivate at least one item in payment-related information stored in the security element upon the resetting of the electronic device.

According to various embodiments of the present disclosure, a method of operating an electronic device may include receiving an input for deleting an application program which manages payment-related information stored in a security element, deleting the application program in response to the received input, identifying at least one item from the payment-related information upon deleting of the application program, and deactivating the identified at least one item.

According to various embodiments of the present disclosure, a method of operating an electronic device may include receiving an input for resetting the electronic device to an initial setup, resetting the electronic device to the initial setup, and deactivating at least one item in payment-related information stored in a security element upon the resetting of the electronic device.

A method and an electronic device thereof according to various embodiments of the present disclosure can prevent and/or reduce the possibility of payment or authentication irrelevant to a user's intention by synchronizing a state of the electronic card and a state of an application program for managing the electronic card.

In addition, the method and the electronic device thereof according to various embodiments of the present disclosure can prevent and/or reduce a leakage of personal information of a user of the electronic device by synchronizing the state of the electronic device and the state of the electronic card.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an electronic device according to various embodiments of the present disclosure;

FIG. 2 is a block diagram illustrating a structure of an electronic device according to various embodiments of the present disclosure;

FIG. 3 is a flowchart illustrating a method of managing an electronic card of a deleted application program according to various embodiments of the present disclosure;

FIG. 4 is a flowchart illustrating a method of deactivating an electronic card corresponding to a deleted application program according to various embodiments of the present disclosure;

FIG. 5 is a flowchart illustrating a method of deactivating a payment card or identification card corresponding to a deleted application program according to various embodiments of the present disclosure;

FIG. 6 is a block diagram illustrating a method of deactivating a credit card or identification card corresponding to a deleted application program according to various embodiments of the present disclosure;

FIG. 7 is a flowchart illustrating a method of managing an electronic card of an electronic device to be reset according to various embodiments of the present disclosure;

FIG. 8 is a flowchart illustrating a method of deactivating an electronic card of an electronic device to be reset according to various embodiments of the present disclosure;

FIG. 9 is a block diagram illustrating a method of deactivating an electronic card of an electronic device to be reset according to various embodiments of the present disclosure; and

FIG. 10 is a block diagram illustrating an electronic device in a network environment according to various embodiments.

### DETAILED DESCRIPTION

Hereinafter, various example embodiments of the present disclosure are described with reference to the accompanying drawings. Further, in the following description of the present disclosure, well-known functions or constructions may not described in detail where they would obscure the disclosure with unnecessary detail. Furthermore, the terms used herein are defined according to the functions of the present disclosure. Thus, the terms may vary depending on user's or operator's intention and usage. Therefore, the terms used herein must be understood based on the descriptions made herein.

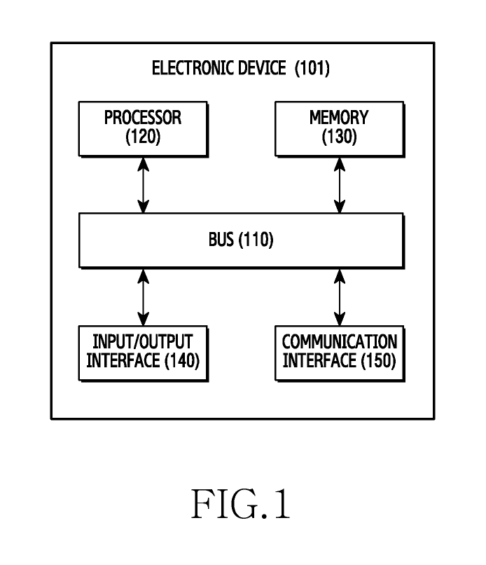

FIG. 1 is a block diagram illustrating an electronic device according to various embodiments of the present disclosure.

Referring to FIG. 1, an electronic device 101 may include a bus 110, a processor (e.g., including processing circuitry) 120, a memory 130, an input/output interface (e.g., including input/output circuitry) 140, and a communication interface (e.g., including communication circuitry) 150. In some embodiments, the electronic device 101 may omit at least one of the elements or may additionally have other elements.

The bus 110 may connect the elements 120 to 150 with each other, and may include a circuit for delivering communication (e.g., a control message or data) between the elements.

The processor 120 may include various processing circuitry, such as, for example, and without limitation, at least one of a dedicated processor, a central processing unit, an application processor, and/or a Communication Processor (CP), or the like. The processor 120 may control, for example, at least one different element of the electronic device 101 and/or may perform communication-related computation or data processing.

According to an embodiment, the processor 120 may install an application program for managing the electronic card. For example, the application program for managing the electronic card may include, without limitation, an electronic wallet application program, a payment card (e.g., credit card) application program, a transportation card application program, a point card application program, an identification card (e.g., ID card) application program, or the like.

According to an embodiment, the processor 120 may store the electronic card in a form of a card applet based on information related to the electronic card registered in the application program for managing the electronic card. For example, the electronic card may be stored in the electronic device 101 and used to process an operation such as payment or user authentication via the communication interface 150. For example, and without limitation, the electronic card may include an electronic payment card for payment of goods, an electronic identification card for user authentication, an electronic transportation card for public transportation, an electronic check card for financial transactions, an electronic membership card for accumulating purchasing points, or the like.

According to an embodiment, the processor 120 may delete the application program. For example, the processor 120 may receive a user input for deleting an electronic wallet application program, and may delete the electronic wallet application program based on the user input.

According to an embodiment, the processor 120 may identify at least one item from payment-related information in response to the deletion of the application program. Herein, the item may be the electronic card, and the payment-related information may include, for example, and without limitation, credit card information related to the electronic card. For example, upon detecting the electronic wallet application program, the processor 120 may identify information and state of the electronic card based on package information of the deleted electronic wallet application program and the payment-related information stored in the security element (e.g., activation or deactivation), and may identify the information and state of the electronic card corresponding to the deleted electronic wallet application program.

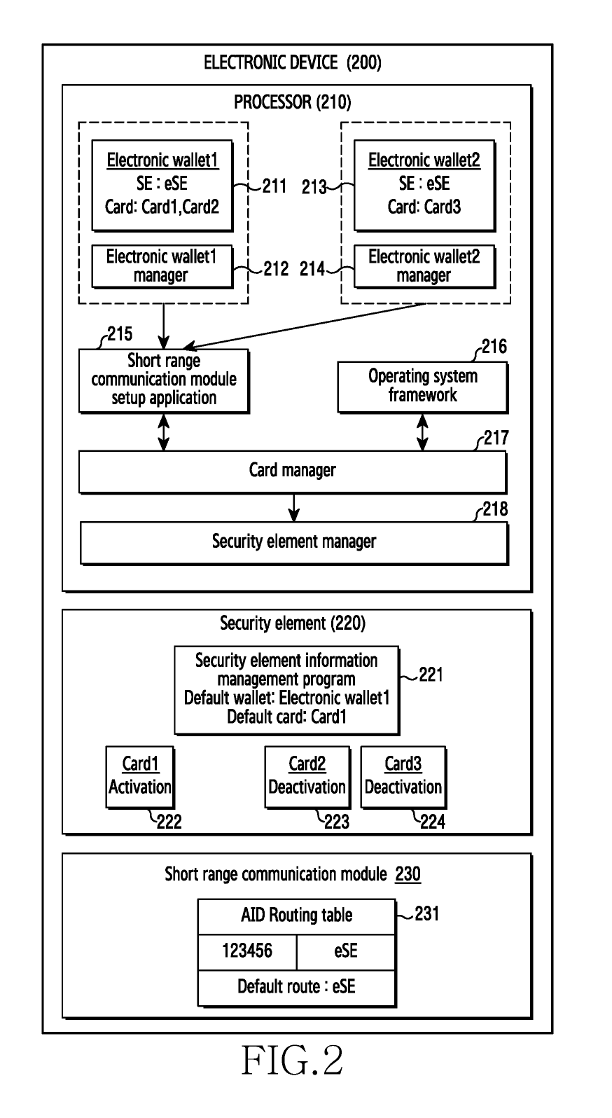

According to an embodiment, the processor 120 may deactivate at least one identified item. For example, between electronic cards 1 and 2 corresponding to the deleted electronic wallet application program (as illustrated, for example, in FIG. 2), the processor 120 may deactivate the electronic card 1 which is in an activation state.

According to an embodiment, the processor 120 may receive a reset of the electronic device 101. Herein, the reset of the electronic device 101 may be a factory reset. For example, the processor 120 may receive the reset of the electronic device 101 to return all setting of the electronic device 101 to an initial state based on a user input.

According to an embodiment, the processor 120 may reset the electronic device 101. For example, the processor 120 may initialize all setting of the electronic device 101 in response to the receiving of the reset of the electronic device 101.

According to an embodiment, the processor 120 may deactivate at least one item in the payment-related information. For example, the processor 120 may deactivate only the activated electronic card among the electronic cards stored in the security element. In addition, unlike this, the processor 120 may deactivate all electronic cards stored in the security element.

According to an embodiment, upon re-installing of the deleted electronic wallet application program, the processor 120 may re-activate the deactivated electronic card based on the user input.

The memory 130 may include a volatile and/or nonvolatile memory. The memory 130 may store, for example, instructions or data related to at least one different element of the electronic device 101. According to an embodiment, the memory 130 may include a security area for storing the electronic card. Unlike this, in addition to the memory 130, the electronic device 101 may include a security element to store the electronic card.

The input/output interface 140 may include various input/output circuitry and deliver, for example, instructions or data input from a user or a different external device to the different element(s) of the electronic device 101, or may output the instructions or data received from the different element(s) of the electronic device 101 to the user or the different external device.

The communication interface 150 may include various communication circuitry and establish communication, for example, between the electronic device 101 and an external device or a server. For example, the communication interface 150 may communicate with the external device by being coupled with a network through wireless communication or wired communication.

The wireless communication may include, for example, at least one of Wireless Fidelity (WiFi), Light Fidelity (LiFi), Bluetooth, Bluetooth Low Energy (BLE), Zigbee, Near Field Communication (NFC), magnetic secure transmission, Radio Frequency (RF), and Body Area Network (BAN).

FIG. 2 is a block diagram illustrating a structure of an electronic device according to various embodiments of the present disclosure. For convenience of explanation, a case where the number of electronic wallet application programs is 2 is taken for example.

Referring to FIG. 2, an electronic device 200 (e.g., the electronic device 101 of FIG. 1) according to various embodiments of the present disclosure may include a processor (e.g., including processing circuitry) 210 (e.g., the processor 120 of FIG. 1), a security element 220, and a short range communication module 230.

The processor 210 may include, for example, an electronic wallet1 application program 211, an electronic wallet1 manger (e.g., including processing circuitry and/or program elements) 212, an electronic wallet2 application program 213, an electronic wallet2 manager (e.g., including processing circuitry and/or program elements) 214, a short range communication setup application 215, an operating system framework 216, a card manager (e.g., including processing circuitry and/or program elements) 217, or a security element manger (e.g., including processing circuitry and/or program elements) 218. The processor 210 may control a series of operations related to the electronic card, and for example, may perform operations of installing, deleting, activating, or deactivating the electronic card.

In an embodiment, the processor 210 may identify an Application ID (AID) corresponding to the electronic wallet1 application program 211 and the electronic wallet2 application program 213, which include at least one electronic card information, and may identify the security element 220 (e.g., eSE) for storing an electronic card (e.g., an electronic card1 222, an electronic card2 223, or an electronic card3 224) to be generated based on the electronic card information.

In an embodiment, the processor 210 may store the electronic card1 222, the electronic card2 223, or the electronic card3 224, in a form of a card applet, in the security element 220 using the electronic wallet1 manager 212 (e.g., a Trusted Service Manager (TSM) agent), the electronic wallet2 manager 214 (e.g., a TSM agent), and each payment server (e.g., a TSM server).

In an embodiment, when the electronic wallet1 application program 211 and the electronic wallet2 application program 213 are installed, the electronic wallet1 manager 212 and the electronic wallet2 manager 214 may be installed together.

In an embodiment, the processor 210 may process operations of storing, deleting, activating, or deactivating in the security element 220 of each of the electronic card1 222, the electronic card2 223, and the electronic card3 224 via the electronic wallet1 manager 212 and the electronic wallet2 manager 214. For example, the processor 210 may store payment-related information including credit card information of the electronic cards 222, 223, and 224 via the electronic wallet1 manager 212 and the electronic wallet2 manager 214.

In an embodiment, the processor 210 may provide the short range communication module setup application 215 with information regarding the specific security element 220 to which each AID is to be routed among a plurality of security elements by using the electronic wallet1 application program 211 and the electronic wallet2 application program 213. In addition, for example, the processor 210 may identify routing of an Application Protocol Data Unit (APDU) to be delivered to an external device in the security element 220 by using the electronic wallet1 application program 211 and the electronic wallet2 application program 213.

In an embodiment, the processor 210 may store a unique AID corresponding to each of the electronic card1 222, the electronic card2 223, and the electronic card3 224 and information related to the security element 220 to be stored, in an AID routing table 231 included in the short range communication module 230. For example, the processor 210 may store an AID (123456) of the electronic card1 222 and information of the security element 220 (e.g., an embedded Security Element (eSE)) in which the electronic card1 222 is stored, in the AID routing table 231 of the short range communication module 230.

In an embodiment, the processor 210 may set a default wallet and a default card based on a user input to prevent and/or reduce an occurrence of duplicate payments between the electronic cards 222, 223, and 224. For example, the processor 210 may set the electronic wallet1 application program 211 and the electronic card1 222 respectively as the default wallet and default card based on the user input. In addition thereto, the processor 210 may set the electronic wallet application program and the electronic card, which are installed first or last, as the default wallet and the default card.

In an embodiment, the processor 210 may set the security element 220, corresponding to the short range communication module 230, in the AID routing table 231 as a default route. For example, if the short range communication module 230 is an NFC chip, the processor 210 may set an eSE suitable for the NFC chip as the default route. In addition thereto, the processor 210 may set the default route in each short range communication module 230 based on a user input or an initial setup.

In an embodiment, the processor 210 delivers an APDU received from an external device to the security element 220 based on routing information of the AID routing table 231, and the electronic cards 222, 223, and 224 matched based on the routing information may process the ADPU to perform payment or user authentication.

The card manager 217 may monitor, for example, a state of the short range communication module setup application 215, the electronic wallet1 application program 211, and the electronic wallet2 application program 213 and a state of the operating system framework 216. For example, the processor 210 may use the card manager 217 to monitor whether a setup value of the short range communication module setup application 215 is changed and to monitor a system event (e.g., a reset of the electronic device 200) which occurs on the operating system framework 216. For example, based on the monitoring result, the processor 210 may sense a change in the default wallet/default route according to a user input or installation or deletion of the electronic wallet1 application program 211 and the electronic wallet2 application program 213. For example, the processor 210 may deliver the sensed change result to the security element manager 218, and may use the security element manger 218 to identify whether the specific electronic cards 222, 223, and 224 are activated or deactivated based on the change result and payment-related information stored in the security element 220.

The security element manger 218 may control, for example, a security element information management program 221 (e.g., Contactless Registry Services (CRS)) installed in the security element 220. The security element manger 218 may communicate with an external service to allocate a space for installing the electronic cards 222, 223, and 224 in a storage space of the security element 220, and may perform operations of searching for information on the electronic cards 222, 223, and 224 installed in the security element 220 and activating and deactivating the electronic cards 222, 223, and 224.

In an embodiment, the processor 210 may identify the payment-related information stored in the security element 220 via the security element manager 218, and may identify the electronic devices 222, 223, and 224 stored in the security element 220 from the identified payment-related information.

The security element 220 may correspond to, for example, a protected storage area included in the electronic device 200, and may be coupled with the processor 210 directly or via the short range communication module 230. For example, the security element 220 may include the security element information management program (e.g., CRS) 221 and the electronic card1 222, electronic card2 223, or electronic card3 224 stored in a form of a card applet. In addition, the security element 220 may store payment-related information including information (e.g., credit card information) required for payment together in each of the electronic card1 222, the electronic card2 223, and the electronic card3 224 or may store it in a separate area.

In an embodiment, the security element 220 may transmit/receive a variety of information related to payment or user authentication by communicating with an external device (e.g., a PoS terminal or a credit card payment terminal) via the short range communication module 230. For example, the security element 220 may activate various electronic cards stored therein by using energy provided from the short range communication module 230 even if power is not provided from a battery. The security element 220 may transmit/receive the variety of information related to payment or user authentication, for example, according to an operation of the activated various cards.

In an embodiment, the security element 220 may include at least one of an embedded Security Element (eSE), a Subscriber Identification Module (SIM), an embedded Subscriber Identification Module (eSIM), and a device host.

The security element information management program 221 may play a role of an interface to have access to the electronic card1 222, electronic card2 223, or electronic card3 223 stored in the security element 220, for example, from the outside (e.g., the processor 210, the short range communication module 230). The security element information management program 221 may store and manage an activation or deactivation state of the electronic cards 222, 223, and 224 existing inside the security element 220, payment-related information for the electronic cards 222, 223, and 224, and default setup information. Herein, the default setup information may include information of a default wallet, a default card, or the like. For example, an AID list may correspond to a set of electronic wallet AIDs used in payment or user authentication. For example, the AID may correspond to a number or character for identifying an electronic wallet application program.

The electronic card1 222, the electronic card2 223, or the electronic card3 224 may be, for example, a card applet capable of performing payment or user authentication. For example, the electronic card1 222, the electronic card2 223, or the electronic card3 224 may correspond to a card applet corresponding to each credit card account issued from a card management server of a card company, or may correspond to a card applet corresponding to a financial account provided from a financial server of a bank.

In an embodiment, the electronic card1 222, the electronic card2 223, or the electronic card3 224 may directly communicate with an external device (e.g., a PoS terminal or a credit card payment terminal) via the short range communication module 230, and may perform payment or user authentication via communication with an external device.

In an embodiment, the electronic card1 222, the electronic card2 223, or the electronic card3 224 may include a variety of data for performing payment or user authentication with each external device. For example, the variety of data may include at least one of a credit card number, a Primary Account Number (PAN) corresponding to a credit card associated with a financial account, at least part of a token with improved security in replacement of the PAN, and/or a cryptogram.

The short range communication module 230 may correspond to, for example, a Near Field Communication (NFC) chip. For example, although it is described in the present specification that the short range communication module 230 corresponds to the NFC chip, this is not for a limitation purpose. The short range communication module 230 may include an NFC controller (not shown) and an RF module controlled by the NFC controller. The RF module may transmit/receive data and/or power, for example, in an electromagnetic induction manner. The short range communication module 230 may be implemented with, for example, a module separated from the processor 210 to transmit/receive various types of payment-related information and user authentication information with respect to the processor 210 and the security element 220.

In an embodiment, the short range communication module 230 may include the AID routing table 231. The AID routing table 231 may include an AID for identifying the electronic card1 222, the electronic card2 223, or the electronic card3 224 and information related to the security element 220 having the electronic card1 222, the electronic card2 223, or the electronic card3 224 stored therein. The short range communication module 230 may create a security channel with respect to the external device based on the AID routing table 231. The short range communication module 230 may transmit, for example, payment-related information based on the activated electronic card (e.g., the electronic card1 222) to the external device via the created security channel.

According to various embodiments of the present disclosure, an electronic device may include a housing, a display exposed through a part of the housing, a security element comprising a secured storage area disposed inside the housing and configured to store payment-related information, a processor disposed inside the housing and operatively coupled with the security element, and a memory disposed inside the housing and operatively coupled with the processor. The memory may store an application program which manages and/or uses the payment-related information. The memory may store instructions which, when executed by the processor, cause the electronic device to: receive an input, e.g., a user input, for selecting the application program, delete the application program in response to the received input, identify at least one item from the payment-related information stored in the security element upon deleting of the application program, and deactivate the identified at least one item.

According to various embodiments, the security element may include at least one of: an embedded Security Element (eSE), a Subscriber Identification Module (SIM), an embedded Subscriber Identification Module (eSIM), and a device host.

According to various embodiments, the payment-related information may include credit card information.

According to various embodiments, the at least one item may include a card applet including a credit card number.

According to various embodiments, the application program may include an electronic wallet application.

According to various embodiments, the instructions, when executed by the processor, may cause the electronic device to: determine whether the deleted application program is an application program based on the security element, determine the at least one item corresponding to the deleted application program based on the payment-related information if the deleted application program is the application program based on the security element, identify an item which is in an activation state from among the at least one item, and deactivate the item which is in the activation state.

According to various embodiments, the instructions may, when executed by the processor, cause the electronic device to: determine whether the deleted application program is a default application program of the security element, deactivate a default payment card stored in the security element if the deleted application program is the default application program of the security element, determine whether an identification card corresponding to the deleted application program is in an activation state in the security element if the deleted application program is not the default application program of the security element, and deactivate the identification card if the identification card is in the activation state.

According to various embodiments of the present disclosure, an electronic device may include a housing, a display exposed through a part of the housing, a security element comprising a secure storage area disposed inside the housing and configured to store payment-related information, a processor disposed inside the housing and operatively coupled with the security element, and a memory disposed inside the housing and operatively coupled with the processor. The memory may store an application program which manages and/or uses the payment-related information. The memory may store instructions which, when executed by the processor, cause the electronic device to: receive an input for resetting the electronic device to an initial setup, reset the electronic device to the initial setup, and deactivate at least one item in payment-related information stored in the security element upon the resetting of the electronic device.

According to various embodiments, the instructions may, when executed by the processor, cause the electronic device to deactivate all items.

According to various embodiments, the instructions may, when executed by the processor, cause the electronic device to: determine whether a setup wizard screen is displayed on a display of the electronic device, identify at least one item which is in an activation state in the security element if the setup wizard screen is displayed on the display of the electronic device, and deactivate the identified at least one item which is in the activation state.

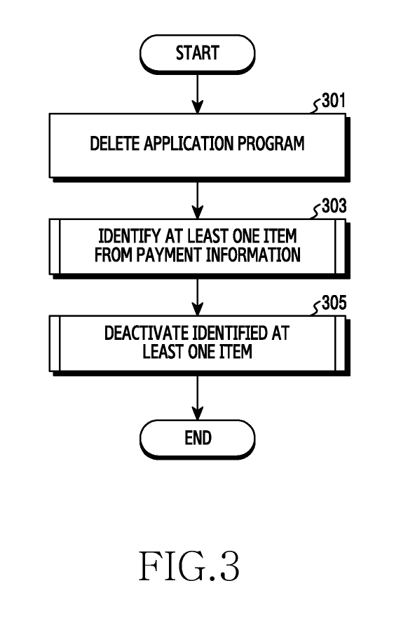

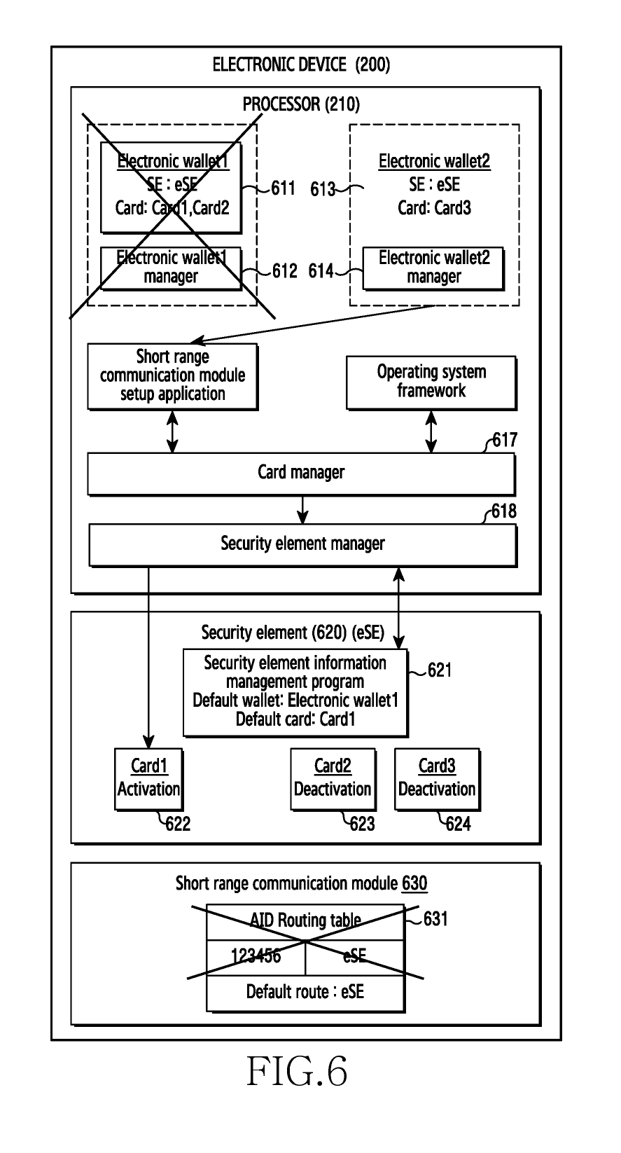

FIG. 3 is a flowchart illustrating a method of managing an electronic card of a deleted application program according to various embodiments of the present disclosure. FIG. 6 is a diagram illustrating a method of deactivating a credit card or identification card corresponding to a deleted application program according to various embodiments of the present disclosure. In the following description, an electronic device may include the electronic device 200 of FIG. 2 or at least part (e.g., the processor 210) of the electronic device 200. For convenience of explanation, a case where a security element is an embedded Security Element (eSE) and a communication module is an NFC chip is described by way of non-limiting example. In addition, for convenience of explanation, a case where an electronic card1 application program 611, an electronic card1 622, and an eSE are respectively set to a default wallet, a default card, and a default route is described by way of non-limiting example. In addition, for convenience of explanation, a case where the electronic card1 622 is an electronic payment card and an electronic card2 623 and an electronic card3 624 are electronic identification cards is described by way of non-limiting example.

Referring to FIG. 3 and FIG. 6, in operation 301, the electronic device 200 (e.g., an electronic device 600 of FIG. 6) may delete an application program. For example, a processor 610 may receive a user input for deleting the electronic wallet1 application program 611, and may delete the electronic wallet1 application program 611 based on the user input. In addition, for example, since the electronic wallet1 application program 611 is deleted, the processor 610 may also delete an AID routing table 631 of an electronic wallet1 manager 612 and a short range communication module 630. However, even if the AID routing table 631 is deleted, default routing information may still remain without being deleted form a security element 620.

In an embodiment, the processor 610 may detect deletion of the electronic card1 application program 611 via a card manager 617, and may provide package information of the deleted electronic card1 application program 611 to a security element manger 618. Herein, the package information may include a package name of the deleted electronic wallet1 application program 611 and an AID registered in a system.

In operation 303, the electronic device 600 may identify at least one item from payment-related information in response to the deletion of the application program. Herein, the item may be the electronic cards 622, 623, and 624, and the payment-related information may include credit card information related to the electronic cards 622, 623, and 624. For example, if the electronic card1 application program is deleted, the processor 610 may identify information and state (e.g., activation or deactivation) of the electronic card1 622, the electronic card2 623, or the electronic card3 624 based on package information of the deleted electronic wallet1 application program 611 and the payment-related information stored in the security element 620, and may identify information and state of the electronic card1 622 and electronic card2 623 corresponding to the deleted electronic wallet1 application program 611.

In operation 305, the electronic device 600 may deactivate at least one identified item. For example, between the electronic card1 622 and the electronic card2 623 corresponding to the electronic wallet1 application program 611, the processor 610 may deactivate the electronic card 1 622 which is in an activation state. Herein, a deactivation state of the electronic cards 622, 623, and 624 may be a state where the electronic cards 622, 623, and 624 cannot respond to an external device (e.g., a PoS terminal or a credit card payment terminal). Accordingly, upon detecting of a specific electronic wallet application program, even if the electronic cards 622, 623, and 624 stored in the security element 620 are not separately deleted, a payment operation can be prevented from being performed via the electronic cards 622, 623, and 624 remaining in the security element 620.

According to an embodiment of the disclosure, when the deleted electronic wallet1 application program 611 is reinstalled, the processor 610 may re-activate the deactivated electronic card1 622 based on a user input.

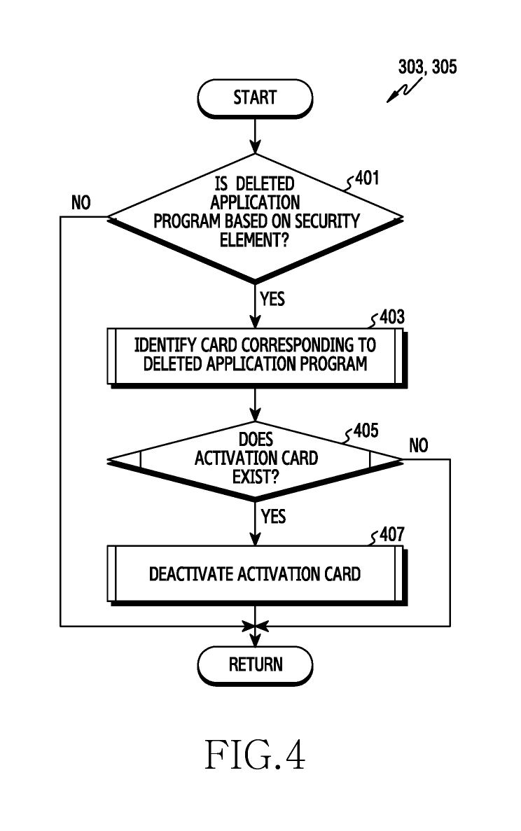

FIG. 4 is a flowchart illustrating a method of deactivating an electronic card corresponding to a deleted application program according to various embodiments of the present disclosure. FIG. 6 is a block diagram illustrating a method of deactivating a payment card or identification card corresponding to a deleted application program according to various embodiments of the present disclosure. Hereinafter, operations of deactivating a card in operations 303 and 305 of FIG. 3 are described. In the following description, an electronic device may include the electronic device 200 of FIG. 2 or at least part (e.g., the processor 210) of the electronic device 200. For convenience of explanation, a case where a security element is an embedded Security Element (eSE) and a communication module is an NFC chip is described by way of non-limiting example.

Referring to FIG. 4 and FIG. 6, in operation 401, the electronic device 200 (e.g., the electronic device 600 of FIG. 6) may identify (determine) whether an application program to be deleted is based on the security element 620 (e.g., eSE). If the short range communication module 630 is an NFC chip, the security element 620 of the NFC chip among the plurality of security elements 620 may be an eSE. In addition, the NFC chip may set the eSE to a default route. For example, if not deleted separately, the electronic card1 622 stored in the eSE set to the default route may remain in the eSE even if the electronic wallet1 application program 611 is deleted. Accordingly, although the electronic wallet1 application program 611 is deleted, the electronic card1 622 which is in an activation state may perform payment with respect to an external device via the short range communication module 630. Therefore, in order to prevent the electronic card1 622 from being used for payment against user's intention, the processor 610 may identify whether the deleted application program is based on the security element 620.

According to an embodiment, the processor 610 may identify respective default routes set in the plurality of short range communication modules 630 included in the electronic device 600, and may identify a relationship between the security element 620 set to the default route and the deleted application program. For example, a relationship between the eSE as the default route of the NFC chip and the electronic wallet1 application program 611 may be identified.

If it is not the deletion of the application program based on the security element 620, returning to FIG. 3, the electronic device 600 may end the procedure.

Otherwise, if it is the deletion of the application program based on the security element 620, proceeding to operation 403, the electronic device 600 may identify a card corresponding to the deleted application program. For example, the processor 610 may provide the security element manager 618 with package information (e.g., a package name, an AID) corresponding to the deleted electronic wallet1 application program 611 via the card manger 617. For example, the processor 610 may identify payment-related information via the security element manager 618 and the security element information management program 621, and may identify the electronic card1 622 and electronic card2 623 corresponding to the deleted electronic card1 application program 611 based on the package information and the payment-related information.

In operation 405, the electronic device 600 may identify (determine) whether an activation card exists. For example, the processor 610 may identify an activation state of the electronic card1 622 and electronic card2 623 corresponding to the deleted electronic wallet1 application program 611 deleted via the security element manger 618 and the security element information management program 621.

If the activation card does not exit, returning to FIG. 3, the electronic device 600 may end the procedure.

Otherwise, if the activation card exists, proceeding to operation 407, the electronic device 600 may deactivate the activation card. For example, if the electronic card1 622 corresponding to the deleted electronic card1 application program 611 is in the activation state, the processor 610 may deactivate the electronic card1 622 via the security element manager 618. Thereafter, returning to FIG. 3, the electronic device 600 may end the procedure.

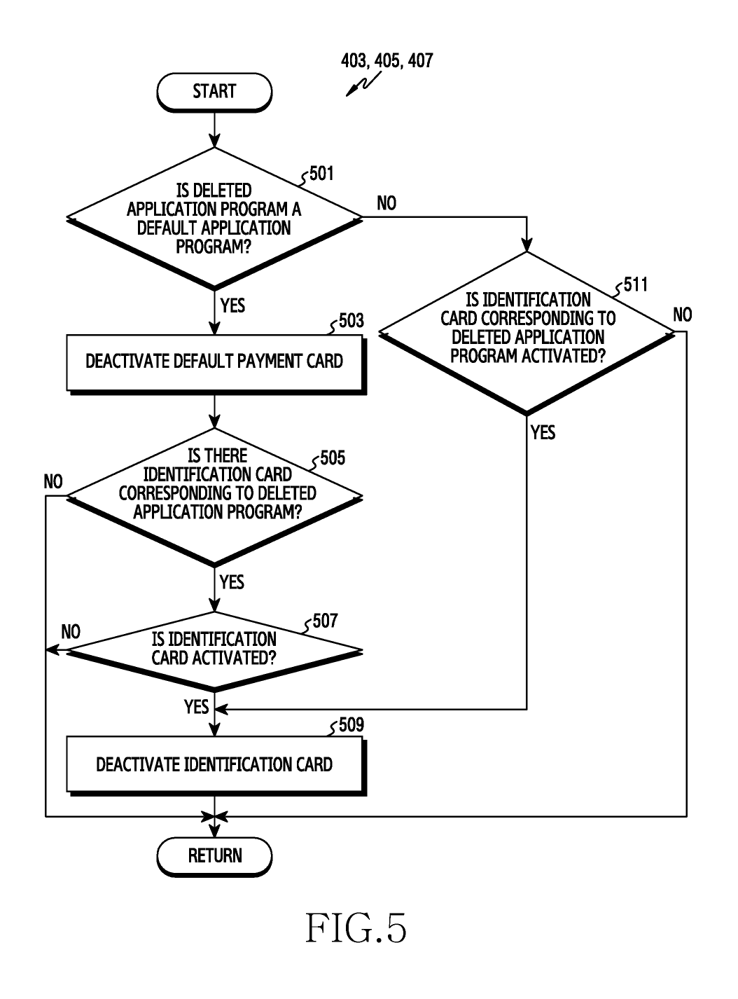

FIG. 5 is a flowchart illustrating a method of deactivating a payment card or identification card corresponding to a deleted application program according to various embodiments of the present disclosure. FIG. 6 is a block diagram illustrating a method of deactivating a payment card or identification card corresponding to a deleted application program according to various embodiments of the present disclosure. Hereinafter, operations of deactivating a card in operations 403, 405, and 407 of FIG. 4 are described. In the following description, an electronic device may include the electronic device 200 of FIG. 2 or at least part (e.g., the processor 210) of the electronic device 200. In addition, for convenience of explanation, a case where the electronic card 1 application program 611, the electronic card1 622, and an eSE are respectively set to a default wallet, a default card, and a default route is described for example. In addition, for convenience of explanation, a case where the electronic card1 622 is an electronic payment card and the electronic card2 623 and the electronic card3 624 are electronic identification cards is described by way of non-limiting example.

Referring to FIG. 5 and FIG. 6, in operation 501, the electronic device 200 (e.g., the electronic device 600) may identify (determine) whether a deleted application program is a default application program. For example, the processor 610 may identify whether the deleted electronic wallet1 application program 611 is a default wallet set in the security element information management program 621. Herein, the default application program (e.g., the default wallets) may be a payment application program for providing an electronic payment card as a program which is set by default in the security element 620. When payment is required (e.g., payment for goods), since a user of the electronic device 600 uses only one payment card, the electronic payment card may be activated by setting only one electronic payment card as a default card, and an electronic payment application program capable of providing the electronic payment card may be the default wallet. Therefore, the processor 610 may identify whether the deleted application program is the default application program to more rapidly process an operation of deactivating a card.

If the deleted application program is the default application program, proceeding to operation 503, the electronic device 600 may deactivate the default payment card. For example, if the deleted electronic wallet1 application program 611 is a default wallet set in the security element 620, the processor 610 may deactivate the electronic card1 622 corresponding to the default payment card.

Otherwise, if the deleted application program is not the default application program, proceeding to step 511, the electronic device 600 may identify (determine) whether the identification card corresponding to the deleted application program is in the activation state. For example, unlike in the figure, if the electronic wallet2 application program 613 capable of providing the electronic identification card for user authentication is deleted, the processor 610 may identify that the deleted electronic wallet2 application program 613 is not the default wallet, and may identify whether the electronic identification card corresponding to the deleted electronic wallet2 application program 612 is in the activation state. As described above, since only one electronic payment card can be activated whereas the electronic identification card can be used for the purpose of user authenticating in each different situation (e.g., an employee card, a license for security facilities), a plurality of electronic identification cards may be in the activation state, independent of the electronic payment card.

If the electronic identification card corresponding to the deleted application program is not activated, returning to the previous figure, the electronic device 600 may end the procedure.

Otherwise, if the electronic identification card corresponding to the deleted application program is activated, proceeding to operation 509, the electronic device 600 may deactivate the electronic identification card. For example, unlike in the figure, if the electronic card3 624 is activated, the processor 610 may deactivate the electronic card3 624 corresponding to the deleted electronic wallet2 application program 613.

In operation 505, the electronic device 600 may identify (determine) whether there is an electronic identification card corresponding to the deleted application program. For example, the processor 610 may use the security element manger 618 and the security element information management program 621 to identify whether the electronic identification card corresponding to the deleted electronic wallet1 application program 611 exists in the security element 620. For example, the deleted electronic wallet1 application program 611 may not an application program dedicated for payment, and may include the electronic identification card in addition to the electronic payment card.

In the absence of the electronic identification card corresponding to the deleted application program, returning to the previous figure, the electronic device 600 may end the procedure.

Otherwise, in the presence of the electronic identification card corresponding to the deleted application program, proceeding to operation 507, the electronic device 600 may identify (determine) whether the electronic identification card is in the activation state. For example, the processor 620 may use the security element manger 618 and the security element information management program 621 to identify whether the electronic identification card (e.g., the electronic card2 623) corresponding to the deleted electronic card1 application program 611 is in the activation state.

If the electronic identification card is not in the activation state, returning to the previous figure, the electronic device 600 may end the procedure.

Otherwise, if the electronic identification card is in the activation state, proceeding to operation 509, the electronic device 600 may deactivate the identification card. For example, the processor 610 may use the security element manager 618 and the security element information management program 621 to deactivate the electronic identification card (e.g., the electronic card2 623) corresponding to the deleted electronic wallet1 application program 611. Thereafter, returning to the previous figure, the electronic device 600 may end the procedure.

According to an embodiment, the application program set to the default wallet may be the application program dedicated for payment, and may include only the electronic payment card. Therefore, when the deleted electronic wallet1 application program 611 is the application program dedicated for payment, the electronic wallet1 application program 611 includes only the electronic payment card, and thus operations 505, 507, and 509 may be omitted.

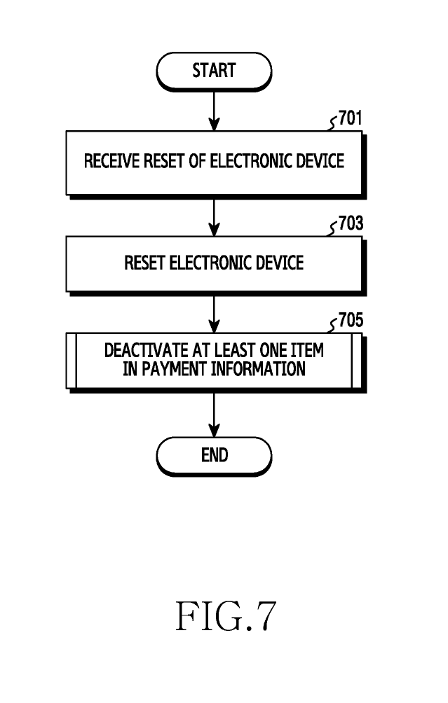

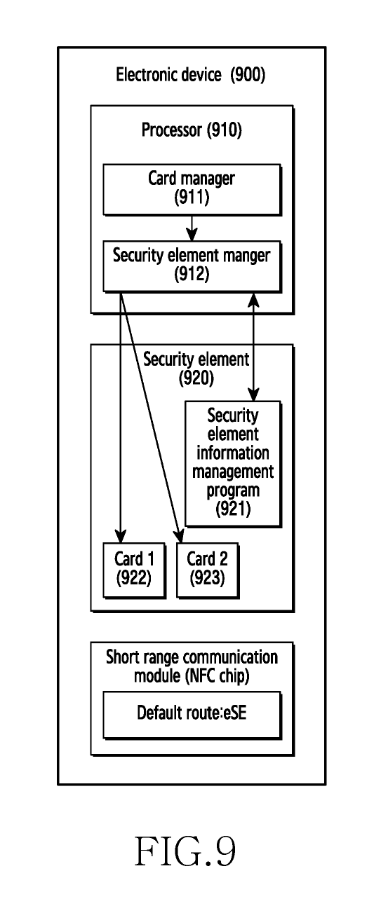

FIG. 7 is a flowchart illustrating a method of managing an electronic card of an electronic device to be reset according to various embodiments of the present disclosure. FIG. 9 is a block diagram illustrating a method of deactivating an electronic card of an electronic device to be reset according to various embodiments of the present disclosure. In the following description, an electronic device may include the electronic device 200 of FIG. 2 or at least part (e.g., the processor 210) of the electronic device 200.

Referring to FIG. 7 and FIG. 9, in operation 701, the electronic device 200 (e.g., an electronic device 900 of FIG. 9) may receive a reset of the electronic device. Herein, the reset of the electronic device may be a factory reset. For example, a processor 910 may receive the reset of the electronic device to return all setting of the electronic device 900 to an initial state based on a user input.

In operation 703, the electronic device 900 may reset the electronic device 900. For example, the processor 910 may initialize all setting of the electronic device 900 in response to the receiving of the reset of the electronic device.

In operation 705, the electronic device 900 may deactivate at least one item in the payment-related information. For example, the processor 910 may use a card manager 911 to detect the reset of the electronic device 900, and may use a security element manger 912 to deactivate electronic cards 922 and 923 based on the payment-related information stored in a security element 920. For example, between the electronic devices 922 and 923 stored in the security element 920, the processor 910 may deactivate only the activated electronic card. In addition, unlike this, the processor 910 may deactivate all of the electronic cards 922 and 923 stored in the security element 920.

According to an embodiment of the present disclosure, upon re-installing of the deleted electronic wallet application program, the processor 910 may re-activate the deactivated electronic card1 922 or the electronic card2 923 based on the user input.

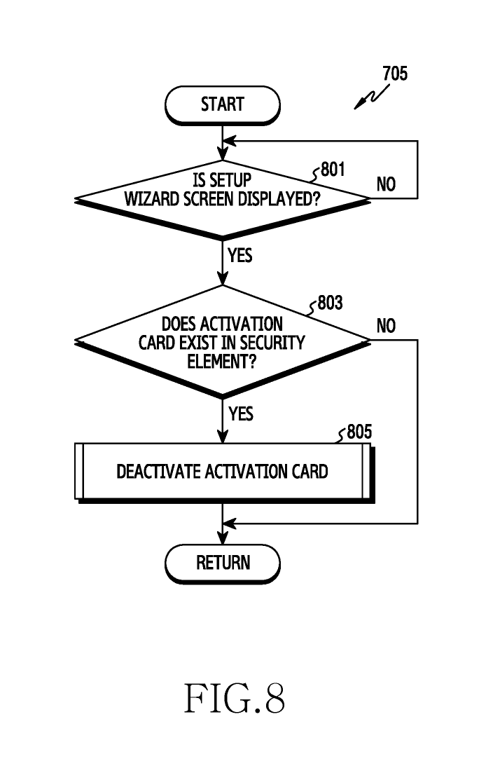

FIG. 8 is a flowchart illustrating a method of deactivating an electronic card of an electronic device to be reset according to various embodiments of the present disclosure. FIG. 9 is a block diagram illustrating a method of deactivating an electronic card of an electronic device to be reset according to various embodiments of the present disclosure. Hereinafter, an operation of deactivating a card in operation 705 of FIG. 7 is described. In the following description, an electronic device may include the electronic device 200 of FIG. 2 or at least part (e.g., the processor 210) of the electronic device 200.

Referring to FIG. 8 and FIG. 9, in operation 801, the electronic device 200 (e.g., the electronic device 900 of FIG. 9) may identify (determine) whether a setup wizard screen is displayed on a display. For example, the processor 910 may use the card manager 911 to identify whether a setup wizard is displayed.

If the setup wizard screen is not displayed on the display, the electronic device 900 may periodically identify (determine) whether the setup wizard screen is displayed.

Otherwise, if the setup wizard screen is displayed on the display, proceeding to operation 803, the electronic device 900 may identify (determine) whether there is an activated card in the security element 920. For example, the processor 910 may use the security element manager 912 and the security element information management program 921 to identify whether the electronic cards 922 and 923 stored in the security element 920 are activated.

In the presence of the activated card in the security element 920, proceeding to operation 805, the electronic device 900 may deactivate the activated card. For example, between the cards 922 and 923 stored in the security element 920, the processor 910 may deactivate the cards 922 and 923 in the activation state.

Otherwise, in the absence of the activated card in the security element 920, returning to the previous figure, the electronic device 900 may end the procedure.

According to various embodiments of the present disclosure, a method of operating an electronic device may include receiving an input, e.g., a user input, for deleting an application program which manages payment-related information stored in a security element, deleting the application program in response to the received input, identifying at least one item from the payment-related information upon deleting of the application program, and deactivating the identified at least one item.

According to various embodiments, the security element may include at least one of: an embedded Security Element (eSE), a Subscriber Identification Module (SIM), an embedded Subscriber Identification Module (eSIM), and a device host.

According to various embodiments, the payment-related information may include credit card information.

According to various embodiments, at least one item may include a card applet including a credit card number.

According to various embodiments, the application program may include an electronic wallet application.

According to various embodiments, identifying of at least one item from the payment-related information may include determining whether the deleted application program is an application program based on the security element, identifying the at least one item corresponding to the deleted application program based on the payment-related information if the deleted application program is the application program based on the security element, identifying an item which is in an activation state from among the at least one item, and deactivating the item which is in the activation state.

According to various embodiments, the method may further include determining whether the deleted application program is a default application program of the security element, deactivating a default payment card stored in the security element if the deleted application program is the default application program of the security element, determining whether an identification card corresponding to the deleted application program is in an activation state in the security element if the deleted application program is not the default application program of the security element, and deactivating the identification card if the identification card is in the activation state.

According to various embodiments of the present disclosure, a method of operating an electronic device may include receiving an input, e.g., a user input, for resetting the electronic device to an initial setup, resetting the electronic device to the initial setup, and deactivating at least one item in payment-related information stored in the security element upon the resetting of the electronic device.

According to various embodiments, the method may further include deactivating all items in the payment-related information upon resetting of the electronic device.

According to various embodiments, the deactivating of the at least one item may include determining whether a setup wizard screen is displayed on a display of the electronic device, identifying at least one item which is in an activation state in the security element if the setup wizard screen is displayed on the display of the electronic device, and deactivating the identified at least one item which is in the activation state.

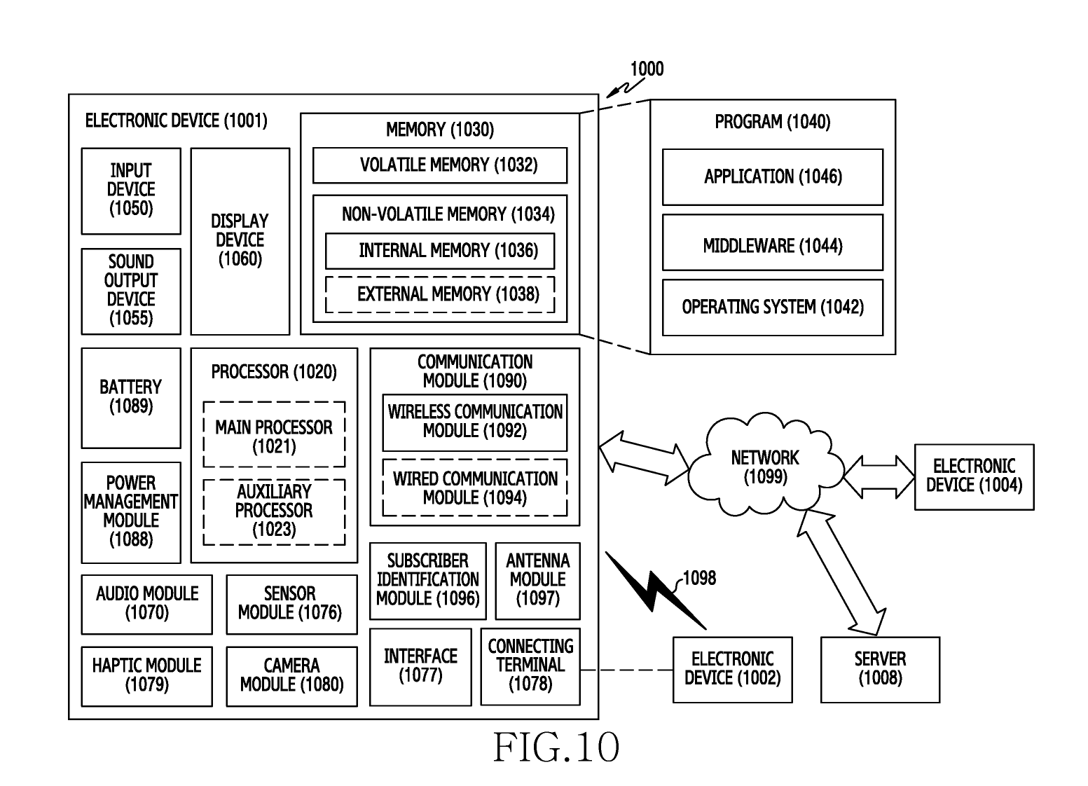

FIG. 10 is a block diagram illustrating an electronic device 1001 in a network environment 1000 according to various embodiments.

Referring to FIG. 10, the electronic device 1001 (e.g., the electronic device 101 of FIG. 1, the electronic device 200 of FIG. 2, the electronic device of FIG. 6, or the electronic device 900 of FIG. 9) in the network environment 1000 may communicate with an electronic device 1002 via a first network 1098 (e.g., a short-range wireless communication network), and/or an electronic device 1004 and/or a server 1008 via a second network 1099 (e.g., a long-range wireless communication network). According to an embodiment, the electronic device 1001 may communicate with the electronic device 1004 via the server 1008.

According to an embodiment, the electronic device 1001 may include a processor (e.g., including processing circuitry) 1020 (e.g., the processor 120 of FIG. 1, the processor 210 of FIG. 2, the processor 610 of FIG. 6, or the processor 910 of FIG. 9), memory 1030 (e.g., the memory 130 of FIG. 1), an input device (e.g., including input/output circuitry) 1050 (e.g., the input/output interface 140 of FIG. 1), a sound output device 1055 (e.g., the input/output interface 140 of FIG. 1), a display device 1060, an audio module (e.g., including audio circuitry) 1070, a sensor module 1076, an interface (e.g., including interface circuitry) 1077, a haptic module (e.g., including haptic circuitry) 1079, a camera module 1080, a power management module 1088, a battery 1089, a communication module (e.g., including communication circuitry) 1090 (e.g., the communication interface 150 of FIG. 1), a subscriber identification module (SIM) 1096, and/or an antenna module 1097.

In some embodiments, at least one (e.g., the display device 1060 or the camera module 1080) of the components may be omitted from the electronic device 1001, or one or more other components may be added in the electronic device 1001. In some embodiments, some of the components may be implemented as single integrated circuitry. For example, the sensor module 1076 (e.g., a fingerprint sensor, an iris sensor, or an illuminance sensor) may be implemented as embedded in the display device 1060 (e.g., a display).

The processor 1020 may include various processing circuitry and execute, for example, software (e.g., a program 1040) to control at least one other component (e.g., a hardware or software component) of the electronic device 1001 coupled with the processor 1020, and may perform various data processing or computation. According to one embodiment, as at least part of the data processing or computation, the processor 1020 may load a command or data received from another component (e.g., the sensor module 1076 or the communication module 1090) in volatile memory 1032, process the command or the data stored in the volatile memory 1032, and store resulting data in non-volatile memory 1034. According to an embodiment, the processor 1020 may include a main processor 1021 (e.g., a central processing unit (CPU) or an application processor (AP)), and an auxiliary processor 1023 (e.g., a graphics processing unit (GPU), an image signal processor (ISP), a sensor hub processor, or a communication processor (CP)) that is operable independently from, or in conjunction with, the main processor 1021. Additionally or alternatively, the auxiliary processor 1023 may be adapted to consume less power than the main processor 1021, or to be specific to a specified function. The auxiliary processor 1023 may be implemented as separate from, or as part of the main processor 1021.

The auxiliary processor 1023 may control at least some of functions or states related to at least one component (e.g., the display device 1060, the sensor module 1076, or the communication module 1090) among the components of the electronic device 1001, instead of the main processor 1021 while the main processor 1021 is in an inactive (e.g., sleep) state, or together with the main processor 1021 while the main processor 1021 is in an active state (e.g., executing an application). According to an embodiment, the auxiliary processor 1023 (e.g., an image signal processor or a communication processor) may be implemented as part of another component (e.g., the camera module 1080 or the communication module 1090) functionally related to the auxiliary processor 1023.

The memory 1030 may store various data used by at least one component (e.g., the processor 1020 or the sensor module 1076) of the electronic device 1001. The various data may include, for example, software (e.g., the program 1040) and input data or output data for a command related thererto. The memory 1030 may include the volatile memory 1032 or the non-volatile memory 1034.

The program 1040 may be stored in the memory 1030 as software, and may include, for example, an operating system (OS) 1042, middleware 1044, or an application 1046.

The input device 1050 may receive a command or data to be used by other component (e.g., the processor 1020) of the electronic device 1001, from the outside (e.g., a user) of the electronic device 1001. The input device 1050 may include various input circuitry, such as, for example, and without limitation, a microphone, a mouse, and/or a keyboard, or the like.

The sound output device 1055 may output sound signals to the outside of the electronic device 1001. The sound output device 1055 may include various sound output circuitry, such as, for example, and without limitation, a speaker and/or a receiver, or the like. The speaker may be used for general purposes, such as playing multimedia or playing record, and the receiver may be used for an incoming call. According to an embodiment, the receiver may be implemented as separate from, or as part of the speaker.

The display device 1060 may visually provide information to the outside (e.g., a user) of the electronic device 1001. The display device 1060 may include, for example, and without limitation, a display, a hologram device, and/or a projector, or the like, and control circuitry to control a corresponding one of the display, hologram device, and projector. According to an embodiment, the display device 1060 may include touch circuitry adapted to detect a touch, or sensor circuitry (e.g., a pressure sensor) adapted to measure the intensity of force incurred by the touch.

The audio module 1070 may include various audio circuitry and convert a sound into an electrical signal and vice versa. According to an embodiment, the audio module 1070 may obtain the sound via the input device 1050, or output the sound via the sound output device 1055 or a headphone of an external electronic device (e.g., an electronic device 1002) directly (e.g., wired) or wirelessly coupled with the electronic device 1001.

The sensor module 1076 may detect an operational state (e.g., power or temperature) of the electronic device 1001 or an environmental state (e.g., a state of a user) external to the electronic device 1001, and then generate an electrical signal or data value corresponding to the detected state. According to an embodiment, the sensor module 1076 may include, for example, and without limitation, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, and/or an illuminance sensor, or the like.

The interface 1077 may support one or more specified protocols to be used for the electronic device 1001 to be coupled with the external electronic device (e.g., the electronic device 1002) directly (e.g., wired) or wirelessly. According to an embodiment, the interface 1077 may include various interface circuitry, such as, for example, and without limitation, a high definition multimedia interface (HDMI), a universal serial bus (USB) interface, a secure digital (SD) card interface, and/or an audio interface, or the like.

A connecting terminal 1078 may include a connector via which the electronic device 1001 may be physically connected with the external electronic device (e.g., the electronic device 1002). According to an embodiment, the connecting terminal 1078 may include, for example, a HDMI connector, a USB connector, a SD card connector, or an audio connector (e.g., a headphone connector),

The haptic module 1079 may convert an electrical signal into a mechanical stimulus (e.g., a vibration or a movement) or electrical stimulus which may be recognized by a user via his tactile sensation or kinesthetic sensation. According to an embodiment, the haptic module 1079 may include various haptic circuitry, such as, for example, and without limitation, a motor, a piezoelectric element, and/or an electric stimulator, or the like.

The camera module 1080 may capture a still image or moving images.

According to an embodiment, the camera module 1080 may include one or more lenses, image sensors, image signal processors, or flashes.

The power management module 1088 may manage power supplied to the electronic device 1001. According to one embodiment, the power management module 1088 may be implemented as at least part of, for example, a power management integrated circuit (PMIC).

The battery 1089 may supply power to at least one component of the electronic device 1001. According to an embodiment, the battery 1089 may include, for example, a primary cell which is not rechargeable, a secondary cell which is rechargeable, or a fuel cell.

The communication module 1090 may include various communication circuitry and support establishing a direct (e.g., wired) communication channel or a wireless communication channel between the electronic device 1001 and the external electronic device (e.g., the electronic device 1002, the electronic device 1004, or the server 1008) and performing communication via the established communication channel. The communication module 1090 may include one or more communication processors that are operable independently from the processor 1020 (e.g., the application processor (AP)) and supports a direct (e.g., wired) communication or a wireless communication. According to an embodiment, the communication module 1090 may include a wireless communication module 1092 (e.g., a cellular communication module, a short-range wireless communication module, or a global navigation satellite system (GNSS) communication module) or a wired communication module 1094 (e.g., a local area network (LAN) communication module or a power line communication (PLC) module). A corresponding one of these communication modules may communicate with the external electronic device via the first network 1098 (e.g., a short-range communication network, such as Bluetooth™, wireless-fidelity (Wi-Fi) direct, or infrared data association (IrDA)) or the second network 1099 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1092 may identify and authenticate the electronic device 1001 in a communication network, such as the first network 1098 or the second network 1099, using subscriber information (e.g., international mobile subscriber identity (IMSI)) stored in the subscriber identification module 1096.

The antenna module 1097 may transmit or receive a signal or power to or from the outside (e.g., the external electronic device) of the electronic device 1001. According to an embodiment, the antenna module 1097 may include one or more antennas, and, therefrom, at least one antenna appropriate for a communication scheme used in the communication network, such as the first network 1098 or the second network 1099, may be selected, for example, by the communication module 1090 (e.g., the wireless communication module 1092). The signal or the power may then be transmitted or received between the communication module 1090 and the external electronic device via the selected at least one antenna.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1001 and the external electronic device 1004 via the server 1008 coupled with the second network 1099. Each of the electronic devices 1002 and 1004 may be a device of a same type as, or a different type, from the electronic device 1001. According to an embodiment, all or some of operations to be executed at the electronic device 1001 may be executed at one or more of the external electronic devices 1002, 1004, or 1008. For example, if the electronic device 1001 should perform a function or a service automatically, or in response to a request from a user or another device, the electronic device 1001, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1001. The electronic device 1001 may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, and without limitation, a portable communication device (e.g., a smart phone), a computer device, a portable multimedia device, a portable medical device, a camera, a wearable device, and/or a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), may refer to a situation in which the element may be coupled with the other element directly (e.g., via wire), wirelessly, or via a third element.

As used herein, the term “module” may include a unit implemented in hardware, software, or firmware or any combinations thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1040) including one or more instructions that are stored in a storage medium (e.g., internal memory 1036 or external memory 1038) that is readable by a machine (e.g., the electronic device 1001). For example, a processor (e.g., the processor 1020) of the machine (e.g., the electronic device 1001) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier and/or a code executable by an interpreter. The machine-readable storage medium may be provided in the form of a non-transitory storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the present disclosure has been described with reference to various example embodiments thereof, it will be understood by those skilled in the art that the various embodiments are intended to be illustrative and not limiting. As such, it will be understood that various modifications, alternatives and equivalents of the various embodiments may be made without departing from the true spirit and full scope of the disclosure as defined, for example, in the appended claims.

What is claimed is:

1. An electronic device comprising:
a housing;
a display exposed through a part of the housing;
a security element comprising a secure storage area disposed inside the housing and configured to store payment-related information;
a processor disposed inside the housing and operatively coupled with the security element; and
a memory disposed inside the housing and operatively coupled with the processor,
wherein the memory is configured to store an application program configured to manage and/or use the payment-related information,
wherein the memory is configured to store instructions which, when executed by the processor, cause the electronic device to:
receive an input for selecting the application program;
delete the application program in response to the received input;
identify at least one item from the payment-related information stored in the security element upon deleting of the application program; and
deactivate the identified at least one item.

2. The electronic device of claim 1, wherein the security element comprises at least one of: an embedded Security Element (eSE), a Subscriber Identification Module (SIM), an embedded Subscriber Identification Module (eSIM), and a device host.

3. The electronic device of claim 1, wherein the payment-related information comprises credit card information.

4. The electronic device of claim 1, wherein the at least one item includes a card applet comprising a credit card number.

5. The electronic device of claim 1, wherein the application program comprises an electronic wallet application.

6. The electronic device of claim 1, wherein the instructions, when executed by the processor, cause the electronic device to:
determine whether the deleted application program is an application program based on the security element;
identify the at least one item corresponding to the deleted application program based on the payment-related information if the deleted application program is the application program based on the security element;
identify an item which is in an activation state from among the at least one item; and
deactivate the item which is in the activation state.

7. The electronic device of claim 6, wherein the instructions, when executed by the processor, cause the electronic device to:
determine whether the deleted application program is a default application program of the security element;
deactivate a default payment card stored in the security element if the deleted application program is the default application program of the security element;
determine whether an identification card corresponding to the deleted application program is in an activation state in the security element if the deleted application program is not the default application program of the security element; and
deactivate the identification card if the identification card is in the activation state.

8. An electronic device comprising:
a housing;
a display exposed through a part of the housing;
a security element comprising a secure storage area disposed inside the housing and configured to store payment-related information;
a processor disposed inside the housing and operatively coupled with the security element; and
a memory disposed inside the housing and operatively coupled with the processor,
wherein the memory is configured to store an application program configured to manage and/or use the payment-related information,
wherein the memory is configured to store instructions, which when executed by the processor, cause the electronic device to:
receive an input for resetting the electronic device to an initial setup;
reset the electronic device to the initial setup; and
deactivate at least one item in payment-related information stored in the security element upon the resetting of the electronic device.

9. The electronic device of claim 8, wherein the instructions, when executed by the processor, cause the electronic device to deactivate all items.

10. The electronic device of claim 8, wherein the instructions, when executed by the processor, cause the electronic device to:
determine whether a setup wizard screen is displayed on a display of the electronic device;
identify at least one item which is in an activation state in the security element if the setup wizard screen is displayed on the display of the electronic device; and
deactivate the identified at least one item which is in the activation state.

11. The electronic device of claim 8, wherein the security element comprises at least one of: an embedded Security Element (eSE), a Subscriber Identification Module (SIM), an embedded Subscriber Identification Module (eSIM), and a device host.

12. The electronic device of claim 8, wherein the payment-related information comprises credit card information.

13. The electronic device of claim 8, wherein the at least one item includes a card applet comprising a credit card number.

14. A method of operating an electronic device, the method comprising:
receiving an input for deleting an application program which manages payment-related information stored in a security element;
deleting the application program in response to the received input;
identifying at least one item from the payment-related information upon deleting of the application program; and
deactivating the identified at least one item.

15. The method of claim 14, wherein the security element comprises at least one of: an embedded Security Element (eSE), a Subscriber Identification Module (SIM), an embedded Subscriber Identification Module (eSIM), and a device host.

16. The method of claim 14, wherein the payment-related information comprises credit card information.

17. The method of claim 14, wherein the at least one item includes a card applet comprising a credit card number.

18. The method of claim 14, wherein the application program comprises an electronic wallet application.

19. The method of claim 14, wherein the identifying of at least one item from the payment-related information comprises:
determining whether the deleted application program is an application program based on the security element;
identifying the at least one item corresponding to the deleted application program based on the payment-related information if the deleted application program is the application program based on the security element;
identifying an item which is in an activation state from among the at least one item; and
deactivating the item which is in the activation state.

20. The method of claim 19, further comprising:
determining whether the deleted application program is a default application program of the security element;
deactivating a default payment card stored in the security element if the deleted application program is the default application program of the security element;
determining whether an identification card corresponding to the deleted application program is in an activation state in the security element if the deleted application program is not the default application program of the security element; and
if the identification card is in the activation state, deactivating the identification card.
